(19) United States
(12) Patent Application Publication
(10) Pub. No.: US 2024/0190526 A1
(43) Pub. Date: Jun. 13, 2024

(54) ADJUSTABLE SEAT POST ASSEMBLY

(71) Applicant: REPEAT BIKES AB, Strängnäs (SE)

(72) Inventor: Bo Martin BAYER, Strängnäs (SE)

(21) Appl. No.: 18/555,164

(22) PCT Filed: Apr. 13, 2022
(86) PCT No.: PCT/SE2022/050370

§ 371 Date: Oct. 12, 2023

(30) Foreign Application Priority Data
Apr. 15, 2021 (SE) 2150466-7

(51) Int. Cl. B62J 1/08; B62J 33/00; B62J 43/30

(52) U.S. Cl. CPC B62J 1/08; B62J 33/00; B62J 43/30; B62J 2001/085

(57) ABSTRACT

Disclosed is a seat post assembly for a human powered vehicle, the seat post assembly including a upper tube and a lower tube where the upper tube is telescopically received in the lower tube, the seat post assembly further including a nut holder tube, a nut, a motor and a lead screw, the motor is attached to the top of the upper tube, the nut holder tube is provided inside the lower tube, the nut is attached in a top portion of the nut holder tube, the lead screw is provided inside the upper tube and the nut holder tube and is with one of its ends attached to an axle of the motor, the seat post assembly is configured to raising or lowering the upper tube relative to the lower tube by rotating the lead screw in forward or backward direction respectively.

### TECHNICAL FIELD OF THE INVENTION

The present invention relates in general to the field of seat posts for a human powered vehicle. In particular, the present invention relates to an electrically adjustable seat post assembly.

### BACKGROUND OF THE INVENTION

The present application generally relates to seats for bicycles, i.e. human powered vehicles, and more particularly to an adjustable seat post assembly for a bicycle seat. Bicycles are known to have a seat or saddle to support the rider in a seated position. The position of the saddle on most bicycles is also adjustable in some manner. The saddle may be adjustable so that a given bicycle can be configured to accommodate different riders of various sizes. The saddle may also be adjustable to allow a rider to set or reset the saddle position on a specific bicycle to accommodate different riding conditions. For example, in certain off-road riding situations, it is beneficial to lower the seat to lower the center of gravity of the rider and to allow the rider to move more freely when riding. This is often advantageous when riding the bicycle at high speeds (e.g., downhill, endure, etc.) over bumpy terrain. After the bumpy terrain, it is often desirable to raise or extend the seat to a higher position so that the rider can comfortably sit on the seat and efficiently pedal the bike.

In one example, a bicycle may have a height adjustable seat post assembly. Thus, the height of the saddle may be selectively adjusted relative to the frame of the bicycles. The typical bicycle has a saddle mounted to a post that is mechanically clamped to a tube of the bicycle frame. When the clamp is released, the saddle and post can be slid up and down to adjust the height of the saddle. However, on more recent higher end bicycles, the seat post may be height adjustable while riding the bicycle by employing some type or hydraulic or mechanical spring assist mechanism. The hydraulic or mechanical mechanism is normally activated by the rider by pressing a lever mounted on the handlebar on the bicycle, which is connected to the seat post assembly by a cable. Some adjustable seat posts activate the hydraulic spring mechanism wirelessly by sending a signal from a remote-control unit on the handlebar to the adjustable seat post assembly, which has an electrical motor that opens and closes valves in the hydraulic spring mechanism.

To raise the saddle or seat on one of the currently available adjustable dropper posts, the rider must un-weigh his or her body from the saddle or seat while activating the spring mechanism in the seat post by pressing the remote-control lever or a lever on the adjustable dropper post. The force of the compressed hydraulic or mechanical spring pushes the saddle or seat up. When the desired position has been reached, the rider lets go of the lever and the saddle or seat stays in the desired position. To lower the saddle, the rider is required to sit and put his or her weight on the saddle while pressing the remote-control lever or a lever on the adjustable dropper post. This motion compresses the hydraulic or mechanical spring. When the desired position has been reached, the rider lets go of the lever and the saddle or seat stays in the desired position.

Alternatively, it is known to make the seat post from two telescoping members that are coupled by a threaded rod driven by an electric motor. The position of the seat or saddle can be adjusted by actuating the motor and turning the threaded rod. Such a system is disclosed in U.S. Pat. No. 6,050,585.

There is a need in the art for a more compact and/or vibration free seat post assembly compared to what is known in the art.

### OBJECT OF THE INVENTION

The present invention aims at obviating the aforementioned problem. A primary object of the present invention is to provide an improved adjustable seat post assembly which is having less vibrations than prior art seat post assemblies, and having less noise than prior art seat post assemblies.

Another object of the present invention is to provide a set post assembly having a smaller retracted length than prior art seat post assemblies but at the same time providing an extracted length capability which is equal or better than prior art seat post assemblies.

### SUMMARY OF THE INVENTION

According to the invention at least the primary object is attained by means of the system having the features defined in the independent claims.

The disclosed seat post assembly provides a seat post that is adjustable in height by rotating a lead screw and nut assembly, driven by an electric motor. This means that the saddle or seat can be lowered or dropped without the rider being required to sit and put his or her weight on the saddle or seat. By rotating a lead screw while keeping a nut fixed, a linear motion can be obtained, which moves the seat or saddle up or down depending on the direction of the rotation. The rotating motion may be obtained by an electrical motor which may be powered by a battery in an electronics module that may be carried under or behind the seat or saddle. The electronics module controls the rotation of the motor. The electronics module could also be placed at the bottom of the disclosed seat post assembly or as a separate module placed inside or outside of the bicycle frame, where the electronics module may be connected to the disclosed seat post assembly via a cable. The motor could also be powered by an external battery such as the battery of an e-bike.

According to the invention, the seat post assembly comprises an upper tube and a lower tube, wherein the upper tube is telescopically received inside the lower tube, a motor attached to the upper tube, a lead screw at its upper end connected to a drive shaft of said motor, a nut and a nut holder tube provided inside the lower tube and attached at its lower end to said lower tube, wherein the nut is attached to a top portion of said nut holder tube, wherein said lead screw is received by said nut, and is provided inside said upper tube and inside said nut holder tube, said seat post assembly being configured to raising or lowering the upper tube relative to the lower tube by rotating said lead screw in forward or backward direction respectively. The seat post assembly further comprises a lead screw end support that is connected to the lower end of the lead screw and is axially displaceable inside the nut holder tube to minimize vibrations and noise during rotation of said lead screw.

Thus, according to the invention the seat post assembly includes a vibration damper or lead screw support which stabilizes the end of the lead screw in the radial direction so that a higher fixity condition can be obtained. To enable the saddle or seat to move up or down at an axial speed which is in line with the axial speeds of the currently available adjustable seat posts, the rotational speed of the lead screw or nut needs to be high. Any rotating shaft or lead screw has a critical rotational speed at which vibrations occur. The critical rotational speed is dependent on the geometry of the shaft or lead screw, and on how the shaft is supported, i.e., its fixity conditions. When rotating a shaft or lead screw with a small diameter, where one end of the shaft or lead screw is free or unsupported, and where the rotational speed is high, vibrations and noise can occur. The disclosed vibration damper or lead screw support removes noise and vibrations that can occur at higher rotational speeds by supporting the free end of the lead screw radially and therefore obtaining a higher fixity condition and consequently increasing the critical rotational speed of the lead screw. The vibration damper or lead screw support can be configured with or without a bearing.

According to various embodiments of the invention, the disclosed seat post assembly may include a configuration where the lead screw is hollow. By using a larger diameter of the lead screw, the critical rotational speed can be increased to or above the level that is required in the disclosed seat post assembly. To minimize the overall weight of the disclosed seat post assembly, the lead screw may have a hollow core or center, which minimizes the weight of the lead screw while maintaining the critical speed of a lead screw with a larger diameter.

According to the invention, the disclosed seat post assembly includes a nut holder tube which holds the nut in an intermediate position inside the seat post assembly. This enables a design where the motor may be placed in the top of the seat post without an increased total axial length of the seat post assembly. According to various embodiments, the nut holder tube may be supported radially by a bushing which slides along the inner surface of the upper tube.

According to various embodiments of the invention, the seat post assembly may include a battery heating configuration where one or several heating elements may be placed near the batteries inside the electronics module. This enables the batteries to supply a high current to the motor, and consequently for the seat post assembly to function properly, also in low temperatures.

Preferred embodiments of the present invention are further defined in the dependent claims.

In various example embodiments of the present invention said lower tube is configured to be removably attached to a frame of a bicycle.

The advantage of these embodiments is that the saddle post may be made to fit existing bicycles.

In various example embodiments said upper tube comprising at its top position a head, wherein a saddle may be removably attached to said head. In various example embodiments a battery may also be removably attached to said head.

The advantage of these embodiments is that various saddles may be fit to the inventive seat post assembly at the same time as the seat post assembly may fit various bicycles.

In various example embodiments of the present invention said battery is provided with a heater to enable sufficient performance of the battery in low temperatures.

The advantage of these embodiments is improved and secured performance independently of the outside temperature.

In various example embodiments according to the present invention said lead screw is hollow in order to minimize vibrations and noise during operation of said lead screw.

The advantage of these embodiments is a reduced weight at the same time as reduced or eliminated vibration during operation of the seat post assembly.

In various example embodiments of the present invention said nut holder tube is configured to be telescopically received in said upper tube.

The advantage of these embodiments is that the seat post assembly may have a minimal retracted length while at the same time is capable of having a relatively long extracted length. Yet another advantage is that said nut holder tube may stabilize any movement perpendicular to the telescopic movement of said upper tube.

Further advantages with and features of the invention will be apparent from the following detailed description of preferred embodiments.

### BRIEF DESCRIPTION OF THE DRAWINGS

A more complete understanding of the abovementioned and other features and advantages of the present invention will be apparent from the following detailed description of preferred embodiments in conjunction with the appended drawings, wherein:

FIG. 1 discloses a side view of one example of a bicycle, which may be fitted with a seat post assembly constructed in the accordance of the disclosure,

FIG. 2A discloses a side view of a seat post assembly, with a saddle installed thereon, and constructed in accordance with this disclosure,

FIG. 2B discloses a perspective view of a seat post assembly, with a saddle installed thereon, and constructed in accordance with this disclosure,

FIG. 2C discloses the seat post assembly of FIG. 2A in a fully raised or extended position,

FIG. 2D discloses the seat post assembly of FIG. 2A in a fully lowered or dropped position,

FIG. 3A discloses a vertical cross-sectional view of the seat post assembly of FIG. 2C,

FIG. 3B discloses a vertical cross-sectional view of the seat post assembly of FIG. 2D,

FIG. 3C discloses a vertical cross-sectional view as in FIGS. 3A and 3B, but with the seat post assembly in an intermediate or partly extended position,

FIG. 3D discloses an enlarged close-up view of central portions of the seat post as depicted in the middle of FIG. 3C,

FIG. 4A discloses a side view and vertical cross-section of a seat post assembly with the motor in the bottom,

FIG. 4B discloses an enlarged close-up view of a central portion of the seat post as depicted in the middle of FIG. 4A,

FIG. 5 discloses a vertical cross-sectional view of the seat post assembly of FIG. 3A, but with a hollow lead screw, in an intermediate or partly extended position,

FIG. 6A discloses a perspective view of the vibration damper with a bearing and with a separate bushing,

FIG. 6B discloses a side view of the vibration damper with a bearing and with a separate bushing,

FIG. 6C discloses a cross-section view of FIG. 6B,

FIG. 7A discloses a perspective view of the vibration damper with a bearing,

FIG. 7B discloses a side view of the vibration damper with a bearing,

FIG. 7C discloses a cross-section view of FIG. 7B,

FIG. 8A discloses a perspective view of the vibration damper without a bearing,

FIG. 8B discloses a side view of the vibration damper without a bearing,

FIG. 8C discloses a cross-section view of FIG. 8B,

FIG. 9A discloses a perspective view of the battery pack and electronics module,

FIG. 9B discloses a side view of the battery pack and electronics module, and

FIG. 9C discloses a vertical cross-sectional view of the seat post assembly of FIG. 9B.

### DETAILED DESCRIPTION OF PREFERRED EMBODIMENTS OF THE INVENTION

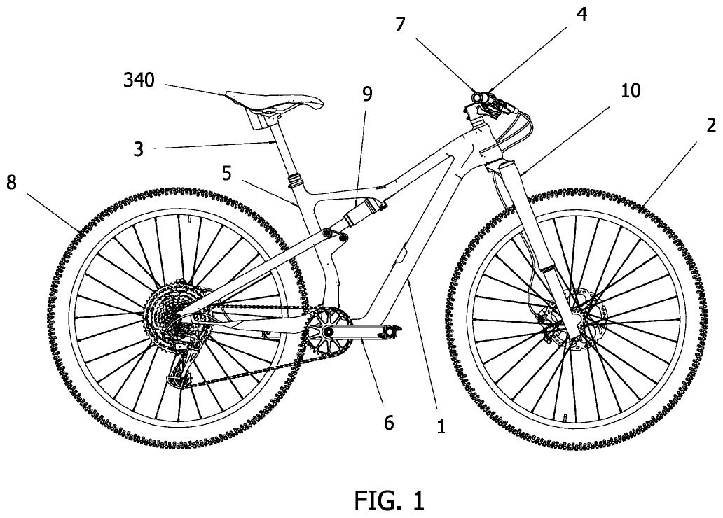

FIG. 1 illustrates one example of a human powered vehicle on which the disclosed seat post assembly may be implemented. In this example, the vehicle is one possible type of bicycle, such as a mountain bicycle. The bicycle has a frame (1), handlebars (7) near a front end of the frame, and a seat or saddle (340) for supporting the rider over a top of the frame. The bicycle also has a first or front wheel (2) carried by a front fork of the frame (10) and supporting the front end of the frame. The bicycle also has a second or rear wheel (8) supporting a rear end of the frame. The rear end of the frame may be supported by a rear suspension component (9). The bicycle also has a drive train with a crank assembly (6) that is operatively coupled via a chain to a rear cassette near a rotation axis of the rear wheel. In this example, the saddle (340) is supported on a seat post assembly (3) constructed in accordance with the teachings of the present disclosure.

While the bicycle depicted in FIG. 1 is a mountain bicycle, the seat post assembly, including the specific embodiments and examples disclosed herein as well as alternative embodiments and examples, may be implemented on other types of bicycles/vehicles. For example, the disclosed seat post assembly (3) may be used on road bicycles, gravel bicycles, cyclocross bicycles, electrical bicycles (e-bicycles), as well as bicycles with mechanical (e.g., cable, hydraulic, pneumatic, etc.) and non-mechanical (e.g., wired, wireless) drive systems. The disclosed seat post assembly (3) may be implemented on other types of two-, three-, and four-wheeled human powered vehicles as well.

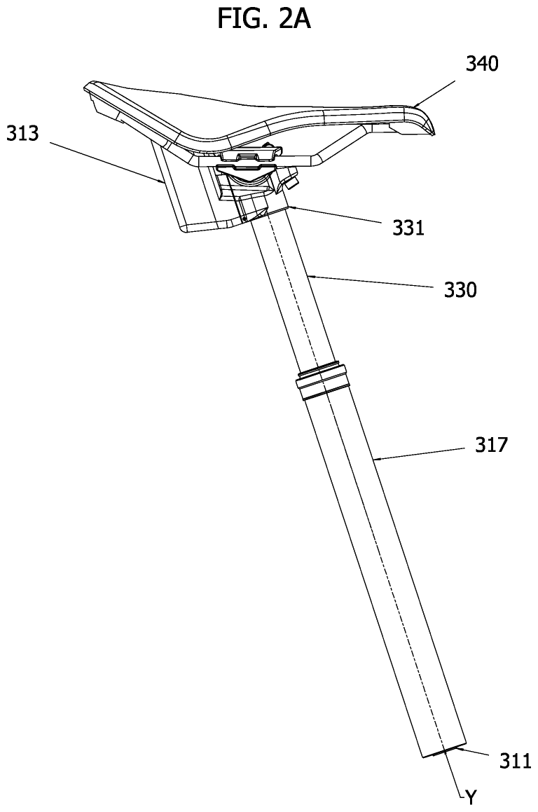

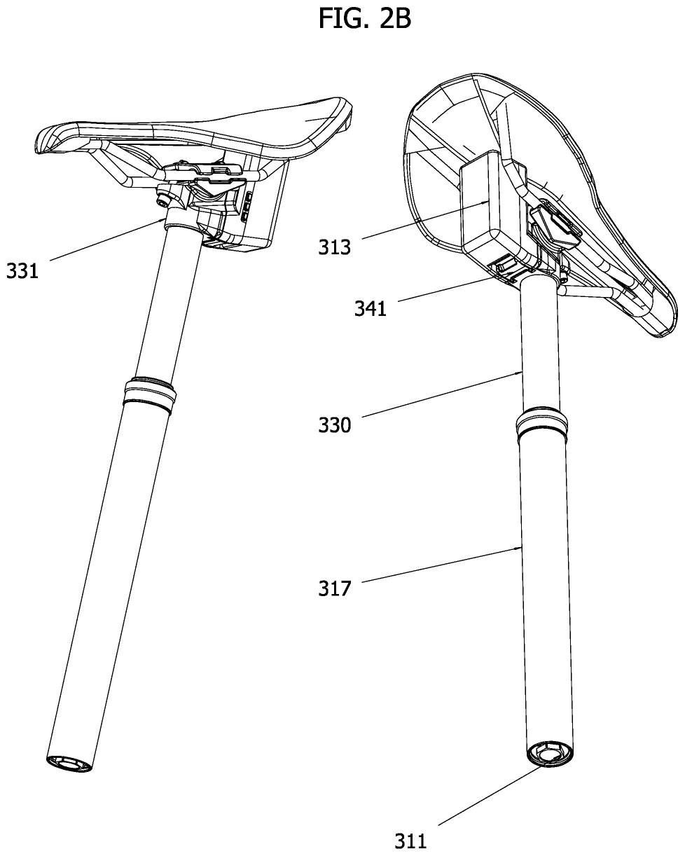

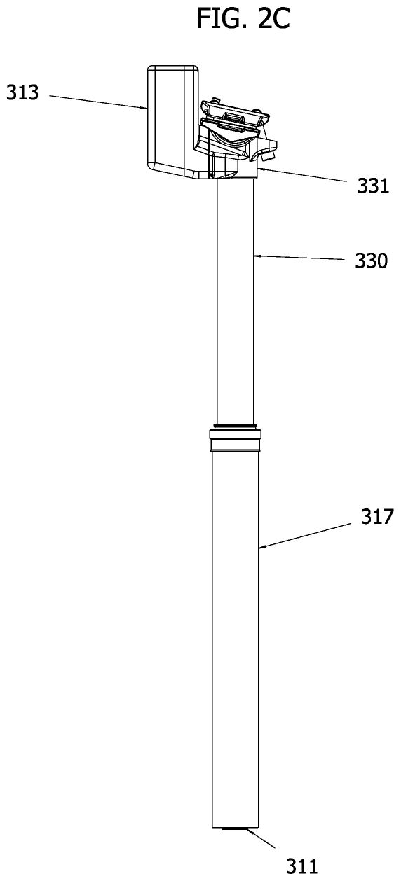

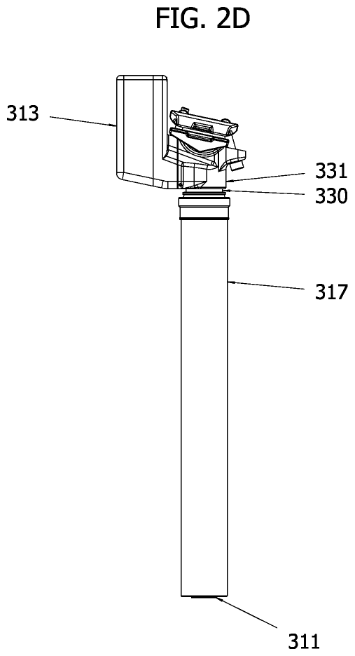

Referring to FIGS. 2A and 2B, the saddle (340) is attached to and carried on top of the seat post assembly. The disclosed seat post assembly may have a first or lower post segment, i.e., a lower tube (317) and a second upper post segment, i.e., an upper tube (330). The two tubes (317, 330) may be movable relative to one another to establish a height of the saddle (340) relative to the frame. The lower tube (317) may be clamped or otherwise secured in a frame tube (5) of the frame (1) in a conventional manner. Thus, the lower tube (317) may be fixed relative to the frame (1) during use and the upper tube (330) may be slidably and telescopically received in the lower tube (317). Also, a head (331) may be fixed to the top of the seat post assembly to the end of the upper tube (330). The battery and electronics module (313) may be attached to the head (331) and may be removable to enable charging of the batteries. Also, the assembly may have a third nut holder tube (311) which may be attached to the bottom of the lower tube (317).

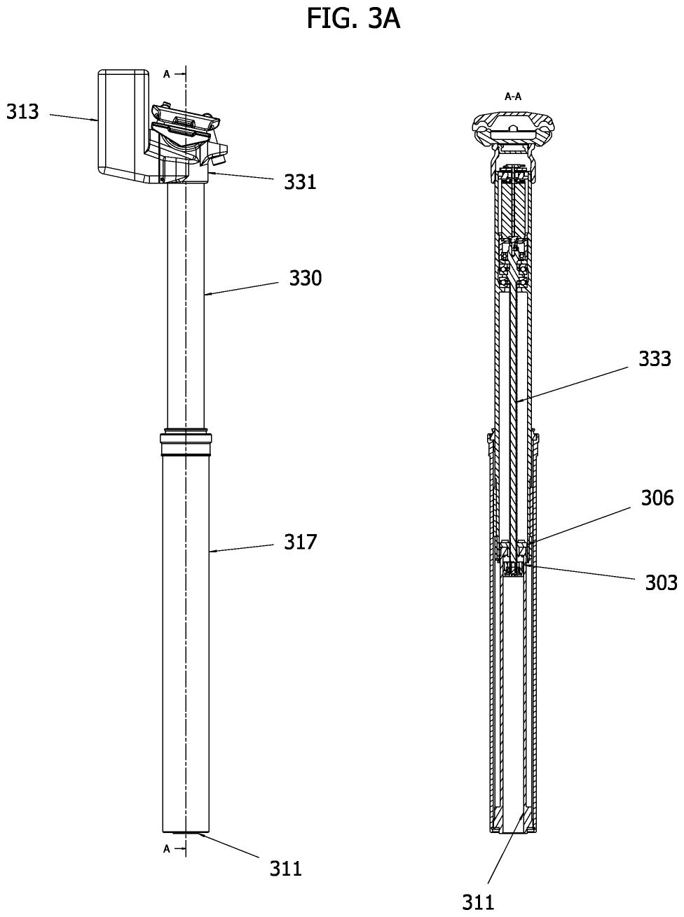

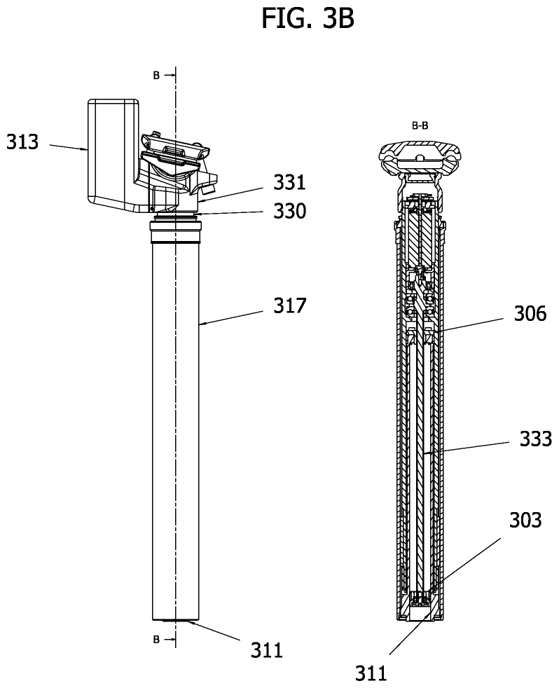

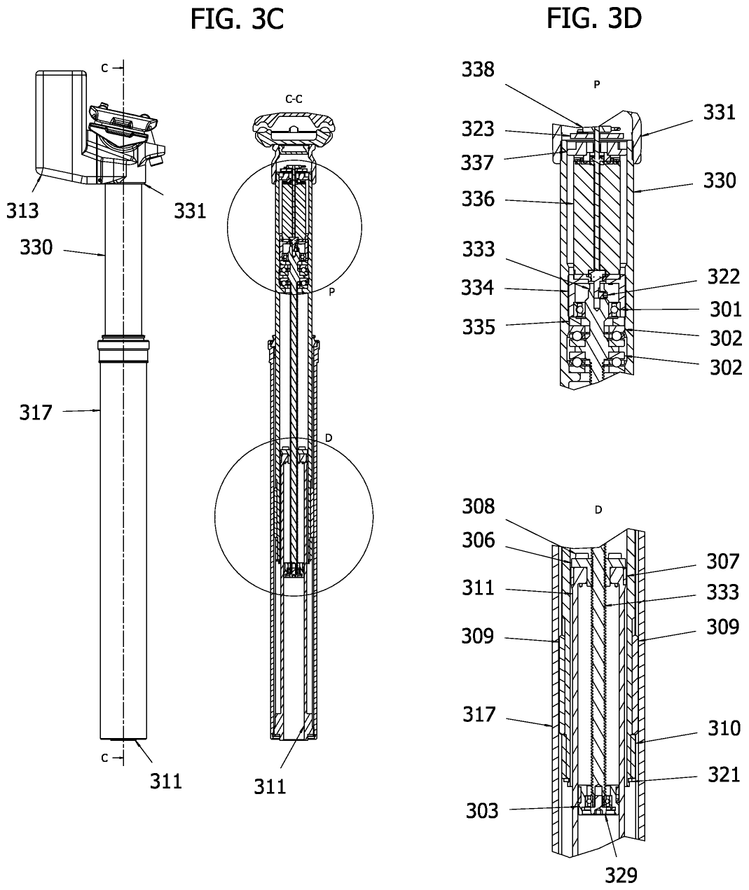

Referring to FIGS. 2C and 3A, the seat post assembly (3) may be positioned in a fully extended position with the upper tube (330) extended upward relative to the lower tube (317) to its fullest extent. Likewise referring to 2D and 3B, the seat post assembly (3) may be positioned in a fully retracted or contracted position with the upper tube (330) retracted into the lower tube (317) to its fullest extent. Raising or lowering the upper tube (330) relative to the lower tube (317) raises or lowers the seat or saddle (340) relative to the frame (1). The seat post assembly (3) can also be positioned in any number of intermediate positions, such as depicted in FIG. 3C, between the fully extended and the fully contracted positions, according to the desire of the rider.

Referring to FIG. 3D, the internal parts of the seat post assembly (3) is now described. A nut holder tube (311) may be attached to the lower tube (317) at the bottom of the lower tube (317). A nut (306) may be attached to the top of the nut holder tube (311). A bushing (307), which slides along the inner surface of the upper tube (330) when the seat or saddle is extended/raised or lowered/dropped, may be attached to the nut holder tube (311). The bushing (307) may support the nut holder tube (311) to keep it stable in the radial direction. At the top of the upper tube (330), a motor (336) and bearing support assembly may be attached to the upper tube (330). The bearing support assembly may consist of a motor and bearing holder (334), a bearing spacer (335), a bearing (301), and thrust bearings (302). A rotation sensor assembly (338) may be attached to the top of the motor (336). The sensor may be connected to the electronics module (313) which registers the number of rotations, the rotational speed etc. The depicted rotation sensor assembly (338) may be a magnetic type of sensor where a magnetic wheel or disc attached to the motor axles rotates and where magnetic sensors on a printed circuit board registers the change in the magnetic field. The rotation sensor may also be of an optical type with an optical sensor and a perforated sensor wheel or disc.

A lead screw (333) is connected to the drive shaft of the motor (336) and may be supported by the bearings (301) and (302). A coupling device may be located intermediate the drive shaft of the motor (336) and the upper end of the lead screw (333), wherein the lead screw is connected to the drive shaft of the motor via the coupling device. The coupling device may be configured to compensate/handle minor concentric imperfections between the lead screw and the drive shaft of the motor, and thereby prevents vibrations and noise, and lowers the frictional torque. The coupling device may be configured to allow minor axial mutual movements and/or mis-location between the lead screw and the drive shaft of the motor. The coupling device may be configured to compensate/handle minor angular misalignments between the lead screw and the drive shaft of the motor, and thereby prevents vibrations and noise. The coupling device may also be considered part of the upper end of the lead screw and/or be located at a suitable location along the leas screw. The coupling device may be constituted by an arrangement co-rotating with the lead screw and the drive shaft of the motor, or may be constituted by a fixed part connected to the upper tube and a rotating part journaled in the fixed part and co-rotating with the lead screw and the drive shaft of the motor. The coupling device entails that the support/bearing arrangement at the upper end of the lead screw may be more robust/rigid, and thereby prevents vibrations and noise. The coupling device may be constituted by a jaw coupling, bellow coupling, cardan joint, etc.

The lead screw (333) may be inserted into and received by the nut (306). To prevent vibrations and noise, a vibrations damper or lead screw end support (303) is attached to the end of the lead screw (333). The outer surface of the vibration damper or lead screw end support (303) glides along the inner surface of the nut holder tube (311). This prevents the end of the lead screw (333) to move in the radial direction. In one configuration, a vibration damper or lead screw end support assembly (303) may be attached to the lead screw (333).

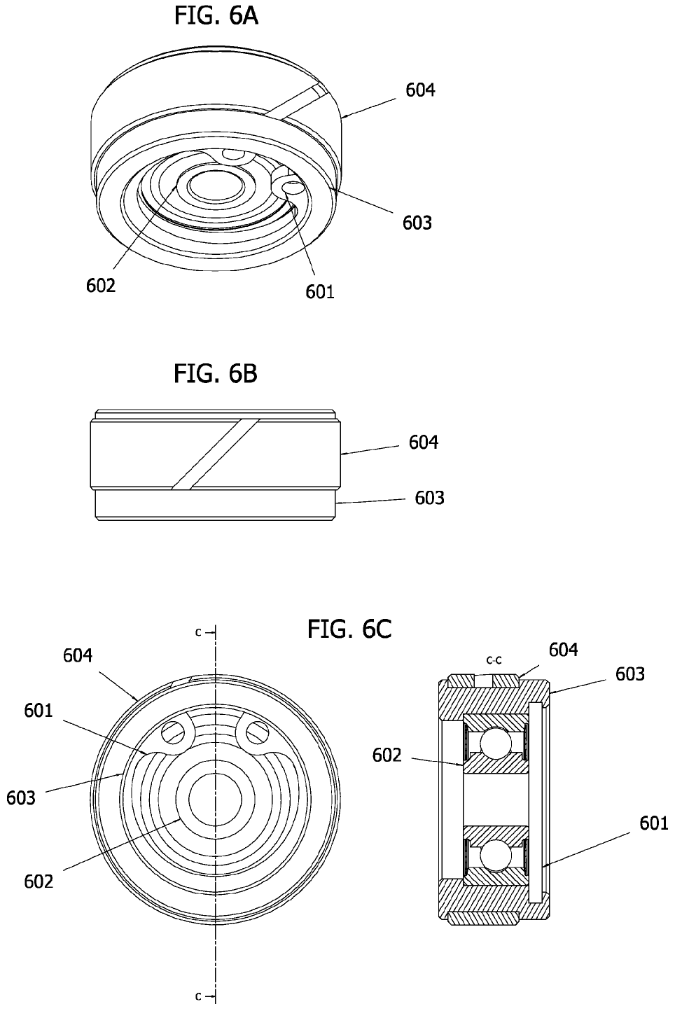

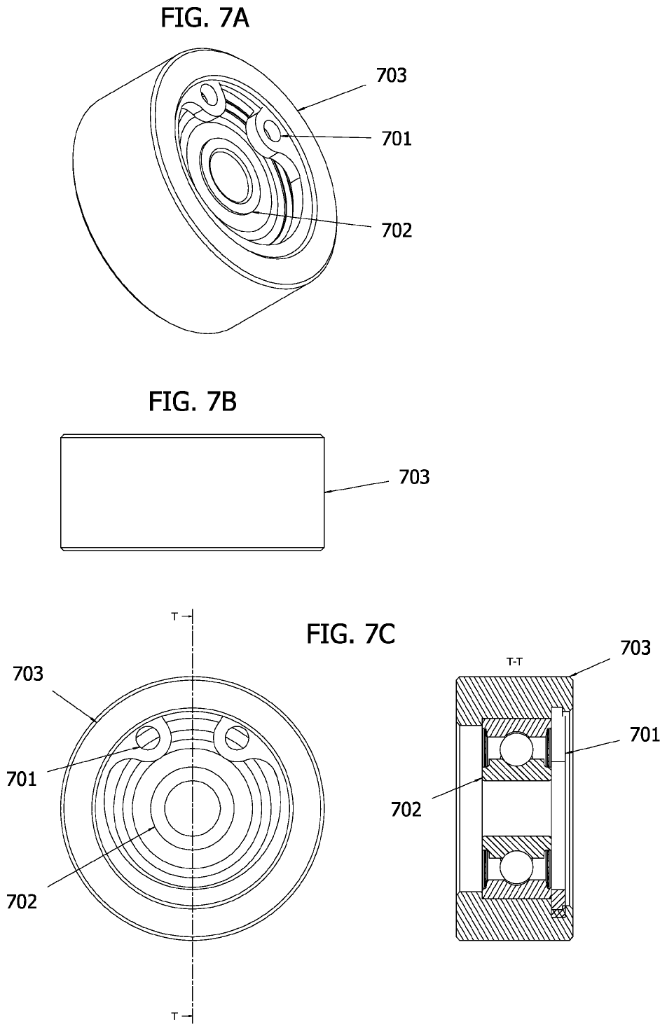

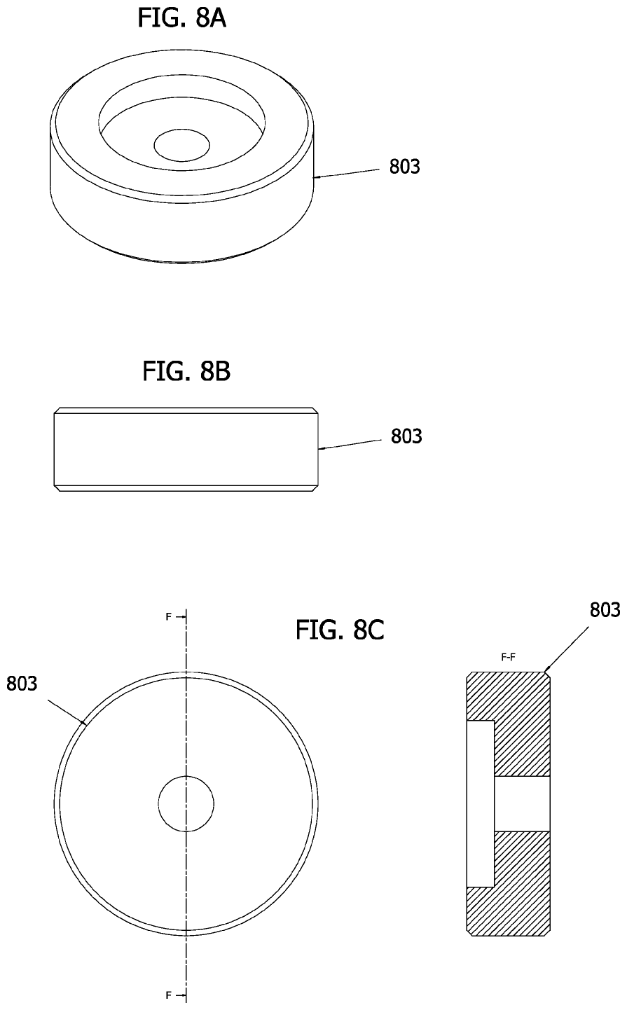

Referring to FIGS. 6A, 6B and 6C, the vibration damper or lead screw end support assembly may consist of body (603), a bearing (602), a lock ring (601) and a bushing (604). The bushing (604) may be made of a low friction material and glides along the inner surface of the nut holder tube (311). In another configuration, as depicted in FIGS. 7A, 7B and 7C, the vibration damper or lead screw end support assembly may consist of a body (703) made of a low friction material, a bearing (702), and a lock ring (701). The outer surface of the body (703) may glide along the inner surface of the nut holder tube (311). In another configuration, as depicted in FIGS. 8A, 8B and 8C, the vibration damper or lead screw end support may consist of a body (803) made of a low friction material. The outer surface of the body (803) may glide along the inner surface of the nut holder tube (311).

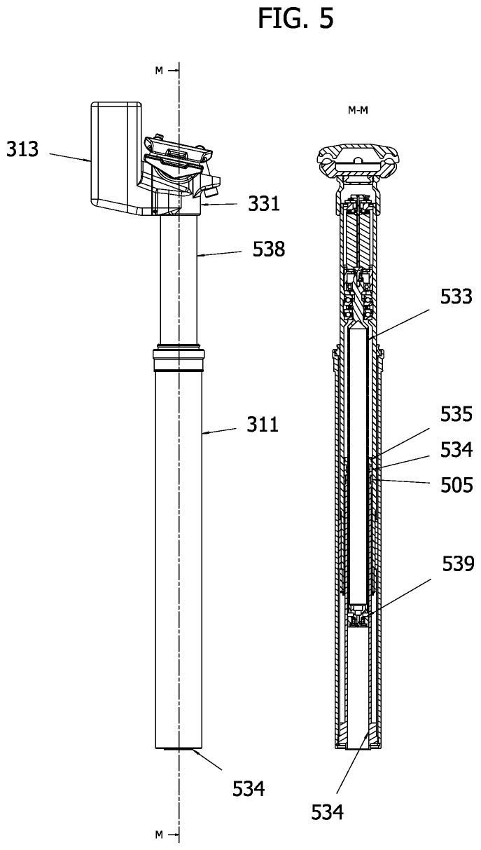

In other configurations, referring to FIG. 5, the vibration and noise problems may further be solved by using a lead screw with a certain diameter and hollow core (533). The critical speed of a rotating shaft is proportional to the diameter of the shaft, meaning that the critical speed is higher if the diameter of the shaft is larger. The diameter of the hollow lead screw (533) may therefore be selected so that the critical speed of the hollow lead screw (533), at the given fixity condition, is higher than the operational speed of the hollow lead screw (533) in the seat post assembly (3). Since a low weight is desirable, weight can be reduced by making the lead screw hollow. The hollow lead screw (533) may also be used together with a vibration damper or lead screw end support (539) which is depicted in FIG. 5.

The dimensions of the lead screw (333) and nut (306) may be selected to that the assembly may be self-locking, meaning that the coefficient of friction is greater than the tangent of the lead angle. This also means that when a force is applied on the saddle in the Y axis, and consequently applied to the lead screw (333), the friction between the lead screw (333) and nut (306) may be large enough to prevent the lead screw (333) from rotating. Consequently, when a rider is seated on the saddle (340), the position of the saddle (340) and the seat post assembly (3) along the Y axis may be fixed.

How the height of the seat post assembly (3) may be adjusted is now described below, referring to FIG. 3D. To change the position of the saddle (340) the rider may lift his/her weight from the saddle and lowers or raises the saddle (340) by using the remote control (4) which may be mounted on the handlebars (7). The remote control (4) may be connected wirelessly or by cable to the electronics module (313) in the seat post assembly (3). When the rider pushes one button on the remote control (4), the motor (336) may turn in one direction, which may rotate the lead screw (333) and lowers or drops the saddle (340). When the rider pushes another button on the remote control (4), the motor (336) may turn in the opposite direction, which may rotate the lead screw (333) and raises or extends the saddle (340). The signal from the remote control (4) may be processed by the microcontroller unit (907) in the electronics module (313) and a current may be sent to the motor (336). The microcontroller unit (907) may, given the pitch of the lead screw, calculate the position of the saddle (340) along the Y axis by measuring the number of revolutions from the rotation sensor (323). The rider can pre-set minimum, maximum, and intermediate positions along the Y axis. By registering the output from the rotation sensor (323), the microcontroller unit (907) can control the position of the saddle (340) according to the pre-set positions by the rider.

Referring to FIG. 2B, the head (331), the electronics module (313), and the upper tube (330) may be fixed to one another and thus may be constrained to always move together as a unit. The electronics module (313) may be held in place to the head (331) by a hatch (341). These parts telescope vertically within and relative to the lower tube (317) along the tube axis Y (FIG. 2B). In one example, an anti-rotation system (not shown) of keys and keyways may be employed to prevent or inhibit rotation of the head (331) relative to the lower tube (317). In one example, the anti-rotation system may include six keys that are spaced 60 degrees apart around the seat post assembly (3). The six keys may be provided in and protruding from corresponding recesses in the outer surface of the upper tube (330) and may engage corresponding keyways provided along the inner surface of the lower tube (317). These keyways in the lower tube (317) may be configured to extend longitudinally in the direction of the tube axis Y and may extend over a majority of, or over most of, its length.

The outer threads of the lead screw match the inner threads of the nut. The nut may or may not have a nut formed outer shape, it may for instance be cylindrical. The nut may be removably attached to the nut holder tube and/or said upper tube or as an alternative the internal threads may be a part of said nut holder tube and/or said upper tube. The number of threads may be less than 50.

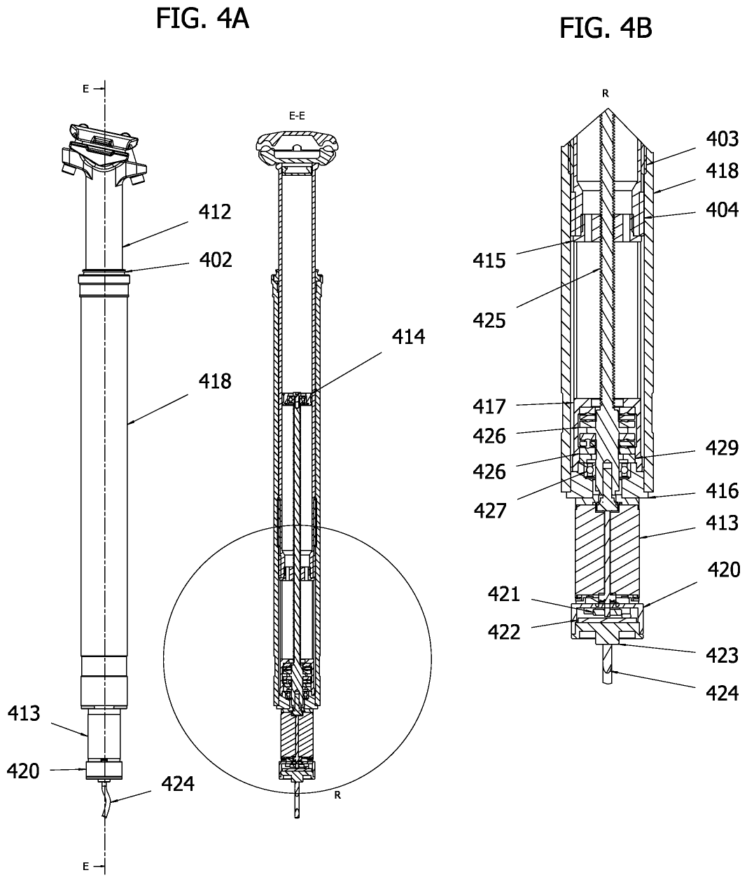

Referring to FIGS. 4A and 4B, not part of the claimed invention, the motor (413) may be attached to the bottom of the lower tube (418). The lead screw (425) may be attached to the axle of the motor (413). The nut (415) may be attached to the upper tube (412). A vibration damper or lead screw end support (414) may be attached to the lead screw (425). A rotation sensor (422) may be placed by the axle of the motor (413) to register the number or rotations of the motor shaft or axle, and lead screw (425).

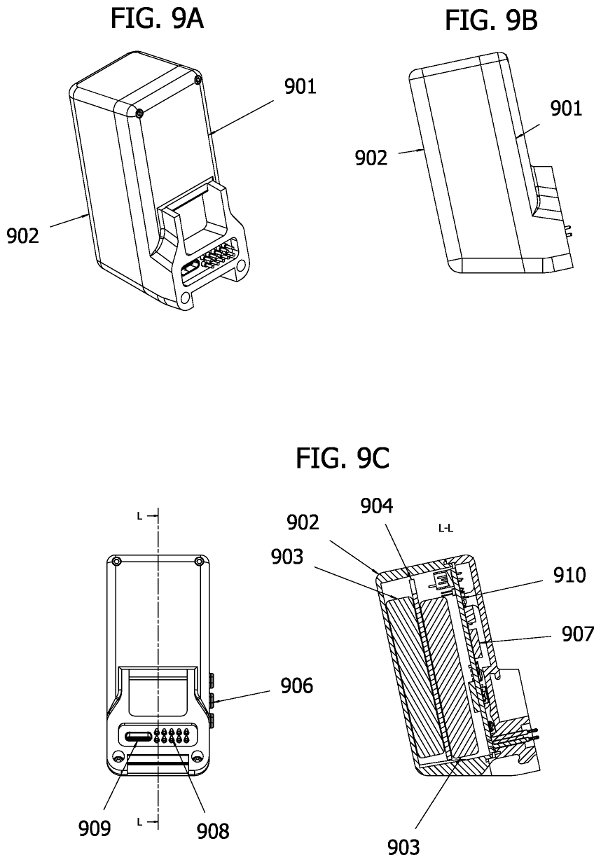

Referring to FIGS. 9A, 9B and 9C, an electronics module may consist of one or several printed circuit boards (910), a microcontroller unit (907), one or several buttons (906), one or several battery cells (903), a power and signal connector (908), a USB connector (909), and one or several heating elements (904). The performance of certain battery cell types, such as battery cells with lithium-based chemistry, may be significantly lower in low temperatures. Certain battery cell types may not be able to supply a sufficiently high current at low temperatures. Since a seat post assembly (3) can be used in low temperatures and since the motor (336) may require a high current to drive the lead screw (333), a heating element may be used to heat the battery cells (903) to a temperature where the batteries can supply a high enough current. The heating element or elements (904) may be placed close to the battery cells and may be connected to the printed circuit board (910). The operation of the heating element or elements (904) may be controlled by the microcontroller unit (907), which may measure the temperature with a temperature sensor (911), which may be placed near the battery or battery cells (903). If the temperature is lower than a set limit, the microcontroller unit (907) may activate and power the heating element or elements (904) until the set temperature has been reached. The battery or battery cells (903) can be charged by connecting one end of a cable to the USB connector (909) and to connect the other end to an external power source, such as a wall charger, a power bank, or a computer.

### FEASIBLE MODIFICATIONS OF THE INVENTION

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the equipment may be modified in all kinds of ways within the scope of the appended claims.

Throughout this specification and the claims which follows, unless the context requires otherwise, the word “comprise”, and variations such as “comprises” or “comprising”, will be understood to imply the inclusion of a stated integer or steps or group of integers or steps but not the exclusion of any other integer or step or group of integers or steps.

1. A seat post assembly for a human powered vehicle, said seat post assembly comprising an upper tube and a lower tube, wherein the upper tube is telescopically received inside the lower tube, said seat post assembly further comprising a motor attached to the upper tube, a lead screw connected at an upper end thereof to a drive shaft of said motor, a nut and a nut holder tube provided inside the lower tube, the lead screw attached at the lead screw's lower end to said lower tube, wherein the nut is attached to a top portion of said nut holder tube, wherein said lead screw is received by said nut, and is provided inside said upper tube and inside said nut holder tube, said seat post assembly being configured to raising or lowering the upper tube relative to the lower tube by rotating said lead screw in forward or backward direction respectively, wherein the seat post assembly further comprising a lead screw end support that is connected to the lower end of the lead screw and is axially displaceable inside the nut holder tube to minimize vibrations and noise during rotation of said lead screw.

2. The seat post assembly according to claim 1, wherein said lower tube is configured to be removably attached to a frame of a bicycle.

3. The seat post assembly according to claim 1, said upper tube comprising at a top position thereof a head, wherein a battery and a saddle may be removably attached to said head.

4. The seat post assembly according to claim 3, wherein said battery is provided with a heater to enable sufficient performance of the battery in low temperatures.

5. The seat post assembly according to claim 1, wherein said lead screw is hollow in order to minimize vibrations and noise during operation of said lead screw.

6. The seat post assembly according to claim 1, wherein said nut holder tube is configured to be telescopically received in said upper tube.

7. A human powered vehicle comprising a seat post assembly according to claim 1.

8. The human powered vehicle according to claim 7, wherein said human powered vehicle is a bicycle.

9. The seat post assembly according to claim 2, said upper tube comprising at a top position thereof a head, wherein a battery and a saddle may be removably attached to said head.

10. The seat post assembly according to claim 9, wherein said lead screw is hollow in order to minimize vibrations and noise during operation of said lead screw.

11. The seat post assembly according to claim 10, wherein said nut holder tube is configured to be telescopically received in said upper tube.

12. A human powered vehicle comprising a seat post assembly according to claim 11.

13. The human powered vehicle according to claim 12, wherein said human powered vehicle is a bicycle.

14. The seat post assembly according to claim 2, wherein said lead screw is hollow in order to minimize vibrations and noise during operation of said lead screw.

15. The seat post assembly according to claim 3, wherein said lead screw is hollow in order to minimize vibrations and noise during operation of said lead screw.

16. The seat post assembly according to claim 4, wherein said lead screw is hollow in order to minimize vibrations and noise during operation of said lead screw.

17. The seat post assembly according to claim 2, wherein said nut holder tube is configured to be telescopically received in said upper tube.

18. The seat post assembly according to claim 3, wherein said nut holder tube is configured to be telescopically received in said upper tube.

19. The seat post assembly according to claim 4, wherein said nut holder tube is configured to be telescopically received in said upper tube.

20. The seat post assembly according to claim 5, wherein said nut holder tube is configured to be telescopically received in said upper tube.
